(19) United States
(12) Patent Application Publication
(10) Pub. No.: US 2025/0322422 A1
(43) Pub. Date: Oct. 16, 2025

(54) ACTION SPECIFIC AWARD TRACKING

(71) Applicant: American Express Services Europe Limited, London (GB)

(72) Inventors: Robert David James Trafford, Pease Pottage (GB); Fraser George Stewart, Burgess Hill (GB)

(21) Appl. No.: 19/246,576

(22) Filed: Jun. 23, 2025

Related U.S. Application Data
(63) Continuation of application No. 18/208,117, filed on Jun. 9, 2023.

(51) Int. Cl. G06Q 30/0208; G06Q 30/0207; G06Q 30/0238

(52) U.S. Cl. CPC G06Q 30/0208; G06Q 30/0215; G06Q 30/0238

(57) ABSTRACT

Disclosed are various embodiments for action specific award tracking. An award multiplier is determined based at least in part on action data. Then, a unique action identifier is generated which is associated with the award multiplier. Next, an action is initiated based at least in part on an action request which comprises the unique action identifier. Then, an award is calculated based at least in part on the unique action identifier in an action receipt. Finally, an award can be deducted based at least in part on a unique action identifier in a cancellation request.

### CROSS-REFERENCE TO RELATED APPLICATIONS

This application is a continuation of, and claims priority to and the benefit of, copending U.S. patent application Ser. No. 18/208,117, entitled “ACTION SPECIFIC AWARD TRACKING” and filed on Jun. 9, 2023, which is incorporated by reference as if set forth herein in its entirety.

### BACKGROUND

In some situations, organizations may wish to reward customers who engage in certain actions. Organizations may choose to use award structures which can vary depending on the circumstances surrounding the rewarded action and/or on the customer. Organizations may also wish to track these award structures for individual actions of a customer.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2-5 are flowcharts illustrating examples of functionality implemented as portions of an application executed in a computing environment in the network environment of FIG. 1 according to various embodiments of the present disclosure.

FIGS. 6-8 are sequence diagrams illustrating interactions between various components of the network environment of FIG. 1 according to various embodiments of the present disclosure.

### DETAILED DESCRIPTION

Disclosed are various approaches for using action specific award tracking. Often, awards are calculated and applied after an action has been completed. If the completion of an action requires multiple steps across multiple systems or services, it can be difficult and cumbersome for a service to access all the relevant data for applying an appropriate reward in a timely manner. Furthermore, when intermediary systems or services are third-party systems or services, it can be even more challenging to reverse an award.

In contrast to other approaches, involving disconnected data which is difficult to track across multiple systems, the approaches herein use unique action identifiers to track, apply, and deduct awards unique to each specific action. In some examples, a unique action identifier is generated which is specific to the award that will apply to the action. In some examples, a unique action identifier is generated which is specific to the user who initiates the action. In some examples, the unique action identifier is used across each of the systems involved in completing and processing an action.

For example, when an action is initiated, an action service can identify data relevant to an award multiplier and send the data to an identifier service. The identifier service can determine an appropriate award multiplier and generate a unique action identifier which links the action to the award multiplier. The identifier service can send the unique action identifier back to the action service, which can forward the unique action identifier to a processing service. After the action has been processed, an award service can determine the appropriate award multiplier from the unique action identifier and apply an award accordingly. If a party wishes to cancel the transaction, a cancellation service can determine a refund amount and an award deduction based at least in part on the unique action identifier. The cancellation service can cancel or reverse a transaction, and claw-back or otherwise recover a previous award.

Thus, various embodiments of the present disclosure can save valuable time and resources in tracking awards compared to approaches using disconnected systems and data. Using unique action identifiers, an action is directly connected to award information. As such, the award information can be stored in one central location and accessed at a later time. Once a unique action identifier has been generated for an action, communications between processing systems need only include the unique action identifier, eliminating the need for error-prone transfers of large file feeds among systems. Thus, when an action is processed by a third party and data is altered, changed, or eliminated, the award information is not lost in the transfer. Rather, using the unique action identifier, a system performing any step of processing an award can easily locate the award information. In addition, various embodiments of the present disclosure can reduce errors in applying and cancelling awards by ensuring the award information is readily identifiable at any stage of the processing or cancelling of the action. Various embodiments of the present disclosure can also reduce the likelihood of gamification of awards structures due to this simplified tracking of award information when cancellations occur.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

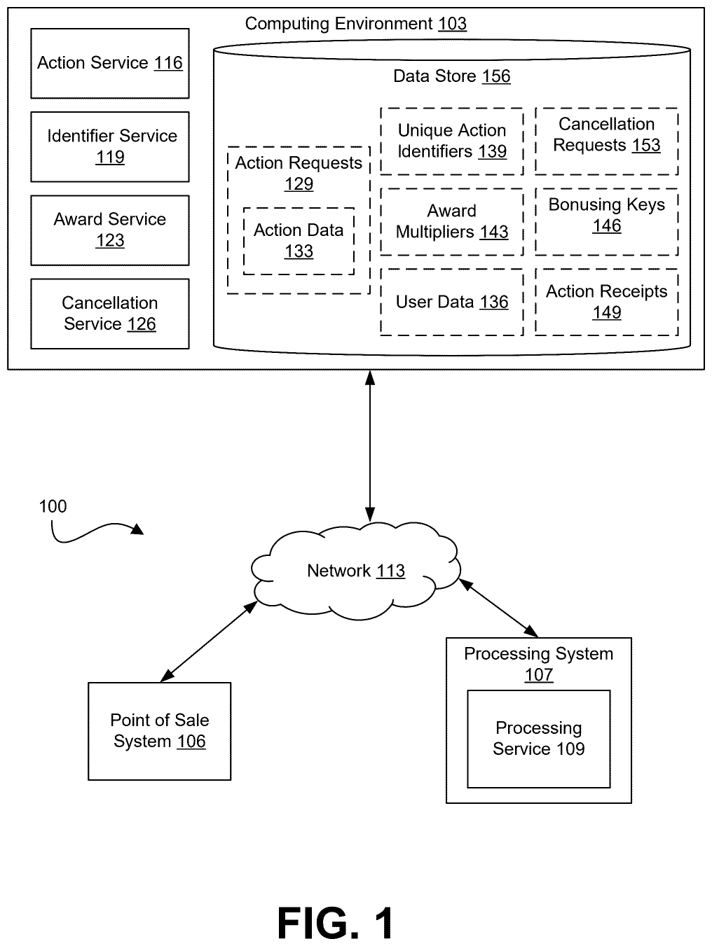

With reference to FIG. 1, shown is a network environment 100 according to various embodiments. The network environment 100 can include a computing environment 103, point-of-sale (PoS) system 106, and a processing service 109 which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include an action service 116, an identifier service 119, an award service 123, a cancellation service 126, and other applications, services, processes, systems, engines, or functionality not discussed in detail herein.

The action service 116 can be executed to receive an action request 129 for a transaction from a point-of-sale system 106, add a unique action identifier to the action request 129, and forward the action request 129 to a processing service 109. For example, the action service 116 could receive an action request 129 from a point- of-sale system 106 for a booking with a third-party vendor. The action service 116 could identify action data 133 associated with the action request 129 such as the type of booking, the identity of the third-party vendor, the date of the booking, a transaction amount for the booking, etc. In addition, the action service 116 could identify user data 136 associated with the user initiating the action request 129, such as the user's spend history, award engagement history, the type of account used for the booking, etc. The action service 116 can forward this data to an identifier service 119 to obtain a unique action identifier 139 based at least in part on the action data 133 and the user data 136. Once the action service 116 receives the unique action identifier 139, the action service 116 could add the unique action identifier 139 to the action request 129. The action service 116 could forward the action request 129, now having the unique action identifier 139, to a processing service 109 of the third-party vendor.

The identifier service 119 can be executed to receive the action data 133 and the user data 136 from the action service 116, generate a unique action identifier 139 based at least in part on the action data 133 and the user data 136, and send the unique action identifier 139 back to the action service 116. For example, the identifier service 119 could determine an award multiplier 143 which is appropriate for the action request 129 based at least in part on the action data 133 and the user data 136. The identifier service 119 could determine the bonusing key 146 which corresponds to the award multiplier 143 and generate a unique action identifier 139 which corresponds to the bonusing key 146. The identifier service 119 could send the unique action identifier 139 to the action service 116.

The award service 123 can be executed to calculate an award based at least in part on an action receipt 149 and add the award to a balance associated with a user. For example, the award service 123 could receive an action receipt 149 from the processing service 109 of the third-party vendor. The award service 123 could determine the action data 133 and the unique action identifier 139 associated with the action receipt 149. The award service 123 could then determine which award multiplier 143 to use based at least in part on the unique action identifier 139 and calculate an award based at least in part on the award multiplier 143 and action data 133 (e.g., the transaction amount). The award service 123 could then apply the award to a balance associated with the user associated with the action receipt 149.

The cancellation service 126 can be executed to cancel an action, which can include a refund of a transaction amount as well as a deduction of an award. In some embodiments, the cancellation service 126 can cancel or reverse a transaction associated with the cancellation request 153, and claw-back or otherwise recover a previous award associated with the transaction. For example, the cancellation service 126 could receive a cancellation request 153 initiated by a user. The cancellation service 126 could identify the action data 133 and the unique action identifier 139 associated with the cancellation request 153. Using the action data 133, the cancellation service 126 could calculate a refund amount. Using the unique action identifier 139, the cancellation service 126 could determine the corresponding award multiplier 143. The cancellation service 126 could determine an award deduction based at least in part on the award multiplier 143 and the action data 133. The cancellation service 126 could then return the refund amount to a user, deduct the award deduction from a balance associated with the user, and forward the cancellation request 153 to the processing service 109 of the third-party vendor.

Also, various data is stored in a data store 156 that is accessible to the computing environment 103. The data store 156 can be representative of a plurality of data stores 156 which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 156 is associated with the operation of the various applications or functional entities described below. This data can include action requests 129, action data 133, user data 136, unique action identifiers 139, award multipliers 143, bonusing keys 146, action receipts 149, cancellation requests 153, and potentially other data.

The action requests 129 can represent records of requests made by a user to initiate transactions with third-party vendors. In some embodiments, a transaction can be a booking, reservation, order, purchase, trade, transfer, or other form of transaction. The action requests 129 can include action data 133. In addition, the action requests 129 can be associated with user data 136.

The action data 133 can represent various information included in the action requests 129. For example, action data 133 can include the type of transaction, the identity of the vendor, the date of the transaction, an amount of the transaction, the type of goods or services of the transaction, a payment card number associated with a user requesting the transaction, and other forms of data about the transaction.

The user data 136 can represent various information about the user who initiated the action request 129. For example, user data 136 can include the user's spend history, award engagement history, the type of account used for the action request 129, other account(s) that the user may have, and other forms of data about the user.

The unique action identifiers 139 can represent tokenized identifiers generated specifically for a corresponding action request 129. In some embodiments, a unique action identifier 139 can be a tokenized payment card number and associated with the user's payment card number used for the action request 129 as well as associated with an award multiplier 143. In some embodiments, a unique action identifier 139 can be specific to the action request 129.

The award multipliers 143 can represent different bonusing level offers for awards. For example, an award multiplier 143 can be an offer of double, triple, quintuple, etc. award points for a transaction. In some embodiments, an award multiplier 143 represents a specific amount of an award (e.g., 10,000 award points, 5,000 airline miles, $100 cash-back, 20% off coupon, etc.). In some embodiments, each award multiplier 143 is unique to a specific award offer. In some embodiments, each award multiplier 143 is associated with a bonusing key 146.

The bonusing keys 146 can represent one or more rules associated with an award multiplier 143 which determine how the unique action identifier 139 will be generated. For example, if a triple award multiplier 143 is applicable to the action request 129, a triple bonusing key 146 can be referenced to generate a unique action identifier 139 which corresponds to the award multiplier 143. In some embodiments, the bonusing key 146 determines a portion of the unique action identifier 139 based at least in part on the award multiplier 143 and a portion of the unique action identifier 139 based at least in part on the action request 129.

The action receipts 149 can represent records of receipts of transactions processed by third-party vendors. The action receipts 149 can correspond to the action requests 129. In some embodiments, an action receipt 149 can include the unique action identifier 139 associated with the corresponding action request 129. In some embodiments, the action receipts 149 include at least a portion of the action data 133. In some embodiments, the action receipts 149 can include at least a portion of the user data 136.

The cancellation requests 153 can represent records of requests to cancel transactions initiated by a user or by third-party vendors. A cancellation request 153 can be associated with an action receipt 149. In some embodiments, a cancellation request 153 can include the unique action identifier 139 associated with the action receipt 149 and corresponding action request 129. In some embodiments, the cancellation requests 153 can include at least a portion of the action data 133. In some embodiments, the action receipts 149 can include at least a portion of the user data 136.

The point-of-sale (PoS) system 106 is representative of a plurality of point-of-sale systems 106 that can be coupled to the network 113. The PoS system 106 can represent any system that can be used to initiate, authorize, or complete a transaction between a user and a vendor. Examples of PoS systems 106 can include cash registers, payment terminals (e.g., transaction card terminals, PIN pads, etc.), virtual payment terminals (e.g., a general purpose computer or mobile device with point of sale software installed), web PoS systems, etc. The PoS system 106 can be maintained and operated by a vendor. The PoS system 106 can be used by a user to initiate an action request 129.

The processing system 107 is representative of a third-party vendor's system for processing the transaction initiated with the action request 129 and generating an action receipt 149. In some embodiments, the processing system 107 can execute a processing service 109. In some embodiments, the processing service 109 can include a payment gateway to gather, store, process, and forward action data 133 to a financial institution associated with the method of payment. In some embodiments, the processing service 109 can generate an action receipt 149 once the transaction has been confirmed.

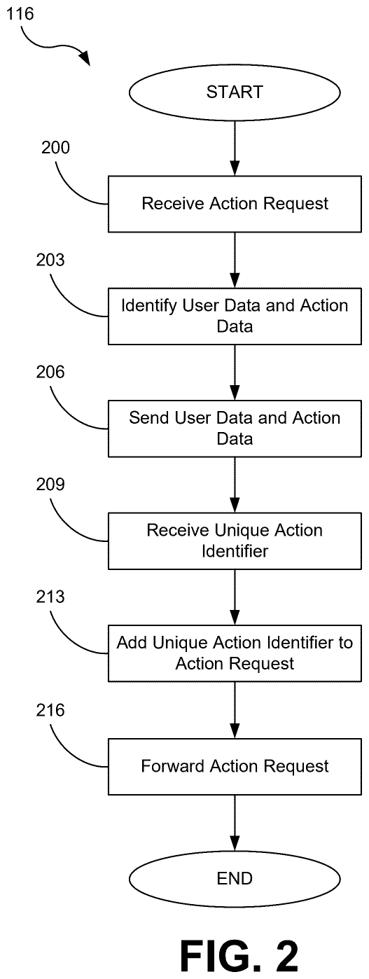

Next, a general description of the operation of the various components of the network environment 100 is provided. Although the following description provides merely an example of the operation of the various components of the network environment 100, other interactions and operations can also be performed by the various embodiments of the present disclosure. More detailed description of the operation of individual components is illustrated in the flowcharts and sequence diagrams of FIGS. 2-8.

To begin, a user can initiate an action request 129 at a PoS system 106. The PoS system 106 can generate action data 133 and add the action data 133 to the action request 129. The POS system 106 can send the action request 129 through the network 113 to the computing environment 103. In some embodiments, the action request 129 can be stored in the data store 156 of the computing environment 103. In some embodiments, the action request 129 can be received by the action service 116 of the computing environment 103. The action service 116 can be configured to receive the action request 129 and extract action data 133 from the action request 129. The action service 116 can be configured to identify user data 136 associated with the action request 129 and send the action data 133 and user data 136 to an identifier service 119.

Next, the identifier service 119 can be configured to receive the action data 133 and user data 136 from the action service 116. The identifier service 119 can use the action data 133 and the user data 136 to determine an appropriate award multiplier 143 for the action request 129. In some embodiments, the identifier service 119 can be configured to determine a bonusing key 146 which corresponds to the award multiplier 143. The identifier service 119 can generate a unique action identifier 139 and send the unique action identifier 139 back to the action service 116. In some embodiments, the identifier service 119 can send the unique action identifier 139 to a data store 156.

The action service 116 can be further configured to receive the unique action identifier 139 from the identifier service 119 and modify the action request 129 to include the unique action identifier 139. The action service 116 can then forward the modified action request 129 through the network 113 to the processing service 109 of a third-party vendor. The processing service 109 of the vendor can process the action request 129 and generate an action receipt 149 including the unique action identifier 139.

Once the processing service 109 has generated the action receipt 149, the processing service 109 can send the action receipt 149 through the network 113 to the computing environment 103. The award service 123 can be configured to receive the action receipt 149 and identify the unique action identifier 139 included in the action receipt 149. Using the unique action identifier 139, the award service 123 can determine the appropriate award multiplier 143 for the action receipt 149. Based at least in part on the award multiplier 143, the award service 123 can calculate an award. The award service 123 can be configured to add this award to a balance associated with the user who initiated the action request 129.

In some situations, a user or a vendor may wish to cancel an action. In some embodiments, the cancellation service 126 can cancel or reverse a transaction associated with the cancellation request 153, and claw-back or otherwise recover a previous award associated with the transaction. The cancellation service 126 can be configured to receive a cancellation request 153. The cancellation service 126 can extract action data 133 from the cancellation request 153. Based at least in part on the action data 133, the cancellation service 126 can calculate a refund amount. In addition, the cancellation service 126 can be configured to identify a unique action identifier 139 associated with the cancellation request 153. Using the unique action identifier 139, the cancellation service 126 can determine the bonusing key 146 and corresponding award multiplier 143. The cancellation service 126 can be further configured to determine an award deduction based at least in part on the award multiplier 143. The cancellation service 126 can be configured to return the refund amount and deduct the award deduction from the balance associated with the user. Finally, in some embodiments, the cancellation service 126 can be configured to forward the cancellation request 153 to the processing service 109 of a vendor.

Referring next to FIG. 2, shown is a flowchart that provides one example of the operation of a portion of the action service 116. The flowchart of FIG. 2 provides merely an example of the many different types of functional arrangements that can be employed to implement the operation of the depicted portion of the action service 116. As an alternative, the flowchart of FIG. 2 can be viewed as depicting an example of elements of a method implemented within the network environment 100.

Beginning with block 200, the action service 116 can be configured to receive an action request 129. In some embodiments, the action request 129 can be received through the network 113 from a POS system 106. In some embodiments, the action service 116 can obtain the action request 129 from the data store 156. In some embodiments, the action service 116 can receive the action request 129 from another system or service in the network environment 100.

At block 203, the action service 116 can identify user data 136 and action data 133. In some embodiments, the action service 116 can extract action data 133 from the action request 129 and identify user data 136 based at least in part on the action data 133. In some embodiments, the action service 116 can extract action data 133 and user data 136 from the action request 129. The action service 116 can be configured to identify the user data 136 and the action data 133 simultaneously or in succession. In some embodiments, the action service 116 can identify action data 133 and user data 136 from the data store 156.

At block 206, the action service 116 can send the user data 136 and action data 133. In some embodiments, the action service 116 sends the user data 136 and action data 133 to the identifier service 119 to determine an award multiplier 143. In some embodiments, the action service 116 uses the user data 136 and the action data 133 to determine the award multiplier 143 and sends the award multiplier 143 to the identifier service 119. In some embodiments, the action service 116 could send the action data 133 and the user data 136 to a data store 156.

Moving to block 209, the action service 116 can receive a unique action identifier 139. In some embodiments, the action service 116 receives the unique action identifier 139 in response to having sent the user data 136 and action data 133. In some embodiments, the action service 116 receives the unique action identifier 139 from the identifier service 119. In some embodiments, the action service 116 obtains the unique action identifier 139 from a data store 156.

At block 213, the action service 116 can add the unique action identifier 139 to the action request 129. In some embodiments, the action service 116 can modify the action request 129 to include the unique action identifier 139. For example, the action service 116 can replace a payment card number included in the action request 129 with the unique action identifier 139.

At block 216, the action service 116 can forward the action request 129. In some embodiments, the action service 116 forwards the action request 129 to a processing service 109. In some embodiments, the action service 116 forwards a modified action request 129 to a processing service 109 of a third-party vendor. After block 216, the flowchart of FIG. 2 comes to an end.

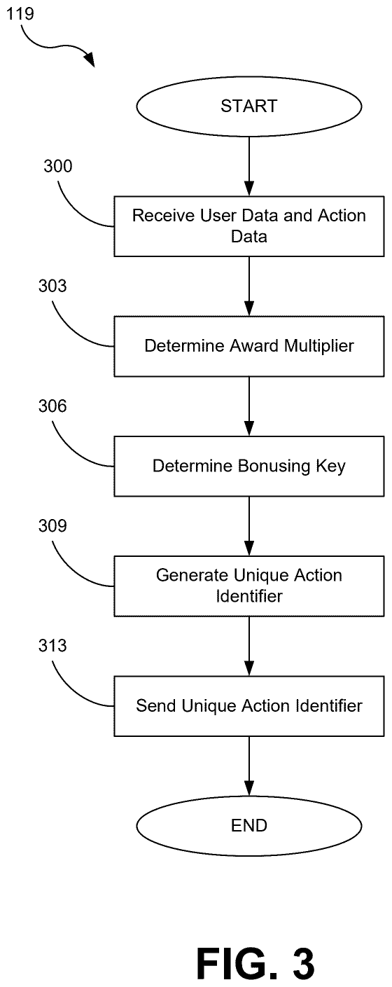

Turning now to FIG. 3, shown is a flowchart that provides one example of the operation of a portion of the identifier service 119. The flowchart of FIG. 3 provides merely an example of the many different types of functional arrangements that can be employed to implement the operation of the depicted portion of the identifier service 119. As an alternative, the flowchart of FIG. 3 can be viewed as depicting an example of elements of a method implemented within the network environment 100.

Beginning with block 300, the identifier service 119 can receive user data 136 and action data 133. In some embodiments, the identifier service 119 can receive the user data 136 and the action data 133 from the action service 116. In some embodiments, the identifier service 119 can receive the user data 136 and the action data 133 simultaneously or in succession. In some embodiments, the identifier service 119 can obtain the user data 136 and the action data 133 from the data store 156.

At block 303, the identifier service 119 can determine an award multiplier 143. The identifier service 119 can be configured to analyze the action data 133 and the user data 136 against a set of rules to determine the appropriate award multiplier 143 for the action request 129. For example, if the action request 129 was made for booking a flight with a preferred airline, one rule could be to add double points. Similarly, if the user data 136 reflects frequent bookings with the preferred airline, another rule could be to add an additional triple points. Thus, in this example, the identifier service 119 would determine an award multiplier 143 of quintuple points. In some embodiments, the identifier service 119 can be configured to receive the award multiplier 143 from the action service 116.

At block 306, the identifier service 119 can determine a bonusing key 146. In some embodiments, the identifier service 119 can be configured to determine a bonusing key 146 which corresponds to the award multiplier 143 determined at block 303. In some embodiments, the identifier service 119 can determine the bonusing key 146 based at least in part on action data 133. In some embodiments, the identifier service 119 can determine the bonusing key 146 based at least in part on user data 136. In some embodiments, the identifier service 119 can determine the bonusing key 146 based at least in part on action data 133 and user data 136.

At block 309, the identifier service 119 can generate a unique action identifier 139. The identifier service 119 can be configured to generate a unique action identifier 139 based at least in part on the award multiplier 143. In some embodiments, the identifier service 119 can generate the unique action identifier 139 based at least in part on the bonusing key 146. In some embodiments, the identifier service 119 can generate the unique action identifier 139 based at least in part on user data 136. The identifier service 119 can be configured to generate the unique action identifier 139 according to a specific format. For example, the identifier service 119 can be configured to generate the unique action identifier 139 such that the unique action identifier 139 resembles a payment card number.

At block 313, the identifier service 119 can send the unique action identifier 139. In some embodiments, the identifier service 119 can send the unique action identifier 139 to the action service 116. In some embodiments, the identifier service can send the unique action identifier 139 to a data store 156. In some embodiments, the identifier service 119 can modify the action request 129 to include the unique action identifier 139. After block 313, the flowchart of FIG. 3 comes to an end.

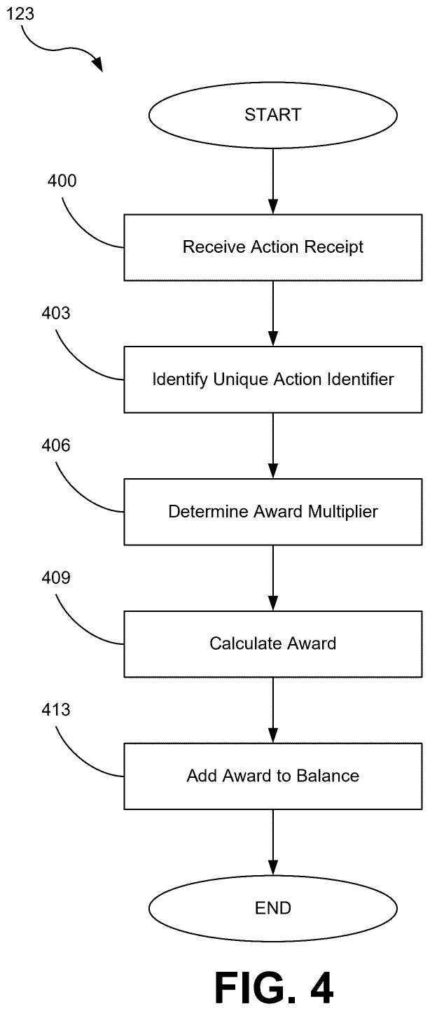

Moving on to FIG. 4, shown is a flowchart that provides one example of the operation of a portion of the award service 123. The flowchart of FIG. 4 provides merely an example of the many different types of functional arrangements that can be employed to implement the operation of the depicted portion of the award service 123. As an alternative, the flowchart of FIG. 4 can be viewed as depicting an example of elements of a method implemented within the network environment 100.

Beginning with block 400, the award service 123 can receive an action receipt 149. In some embodiments, the award service 123 can receive the action receipt 149 from a processing service 109. In some embodiments, the award service 123 can obtain the action receipt 149 from a data store 156.

At block 403, the award service 123 can identify a unique action identifier 139. In some embodiments, the award service 123 can be configured to search the action receipt 149 and identify the unique action identifier 139 from the contents of the action receipt 149. In some embodiments, the award service 123 can be configured to identify the unique action identifier 139 based at least in part on the action receipt 149 received at block 400.

At block 406, the award service 123 can determine the award multiplier 143. The award service 123 can be configured to determine the award multiplier 143 based at least in part on the action receipt 149 received at block 400. In some embodiments, the award service 123 can determine the award multiplier 143 based at least in part on the unique action identifier 139 identified at block 403. In some embodiments, the award service 123 can interact with the identifier service 119 to determine the award multiplier 143. For example, the award service 123 could send the unique action identifier 139 obtained at block 403 to the identifier service 119 which could use the unique action identifier 139 to determine the corresponding bonusing key 146 and determine the award multiplier 143 based at least in part on the bonusing key 146. In this example, the identifier service 119 could send the award multiplier 143 to the award service 123. In some embodiments, the award service 123 can determine the bonusing key 146 based at least in part on the unique action identifier 139 identified at block 403 and use the bonusing key 146 to determine the award multiplier 143.

At block 409, the award service 123 can calculate an award. The award service 123 can be configured to calculate an award for the action request 129 associated with the action receipt 149 received at block 400. In some embodiments, the award service 123 can be configured to calculate the award based at least in part on the award multiplier 143 determined at block 406. In some embodiments, the award service 123 can be configured to calculate the award based at least in part on user data 136. In some embodiments, the award service 123 can be configured to calculate the award based at least in part on action data 133 associated with the action receipt 149.

At block 413, the award service 123 can add the award to a balance. The award service 123 can be configured to add the award calculated at block 409 to a balance associated with a user. In some embodiments, the award service 123 can add the award to a balance associated with the action receipt 149 received at block 400. In some embodiments, the award service 123 can be configured to add the award to some other balance. After block 413, the flowchart of FIG. 4 comes to an end.

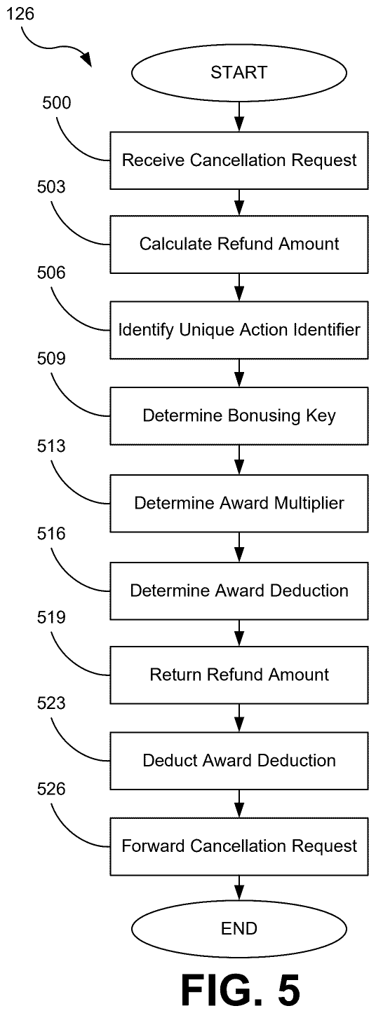

Referring next to FIG. 5, shown is a flowchart that provides one example of the operation of a portion of the cancellation service 126. The flowchart of FIG. 5 provides merely an example of the many different types of functional arrangements that can be employed to implement the operation of the depicted portion of the cancellation service 126. As an alternative, the flowchart of FIG. 5 can be viewed as depicting an example of elements of a method implemented within the network environment 100.

Beginning with block 500, the cancellation service 126 can receive a cancellation request 153. The cancellation service 126 can receive a cancellation request 153 from a user, a PoS system 106, a processing service 109 of a third-party vendor, or some other source. In some embodiments, the cancellation service 126 can receive a cancellation request 153 from another service (e.g., a fraud service, a client relations service, etc.) within the computing environment 103.

At block 503, the cancellation service 126 can calculate a refund amount. In some embodiments, the cancellation service 126 can extract action data 133 associated with the cancellation request 153 received at block 500 and calculate the refund amount based at least in part on the action data 133. In some embodiments, the cancellation service 126 can calculate a cancellation amount based at least in part on the action data 133. In some embodiments, the cancellation service 126 can calculate the refund amount based at least in part on the cancellation amount.

At block 506, the cancellation service 126 can identify a unique action identifier 139. For example, the cancellation service 126 can be configured to identify a unique action identifier 139 associated with the cancellation request 153 received at block 500. In some embodiments, the cancellation service 126 can be configured to identify a unique action identifier 139 based at least in part on action data 133 associated with the cancellation request 153.

At block 509, the cancellation service 126 can determine the bonusing key 146. For example, the cancellation service 126 can be configured to determine the bonusing key 146 based at least in part on the cancellation request 153 received at block 500. In some embodiments, the cancellation service 126 can determine the bonusing key 146 based at least in the unique action identifier 139 identified at block 506. In some embodiments, the cancellation service 126 can interact with the identifier service 119 to determine the bonusing key 146. For example, the cancellation service 126 can forward the unique action identifier 139 identified at block 506 to the identifier service 119 to determine the corresponding bonusing key 146. In some embodiments, the identifier service 119 can return the bonusing key 146 to the cancellation service 126. In some embodiments, the identifier service 119 could determine the award multiplier 143 based at least in part on the bonusing key 146 and return the award multiplier 143 to the cancellation service 126.

At block 513, the cancellation service 126 can determine the award multiplier 143. The cancellation service 126 can be configured to determine the award multiplier 143 based at least in part on the cancellation request 153 received at block 500. In some embodiments, the cancellation service 126 can determine the award multiplier 143 based at least in part on the unique action identifier 139 identified at block 506. In some embodiments, the cancellation service 126 can interact with the identifier service 119 to determine the award multiplier 143. For example, the cancellation service 126 could send the unique action identifier 139 obtained at block 506 to the identifier service 119 which could use the unique action identifier 139 to determine the corresponding bonusing key 146 and determine the award multiplier 143 based at least in part on the bonusing key 146. In this example, the identifier service 119 could send the award multiplier 143 to the cancellation service 126. In some embodiments, the identifier service 119 could determine the award multiplier 143 based at least in part on the unique action identifier 139 and return the award multiplier 143 to the cancellation service 126. In some embodiments, the cancellation service 126 can determine the award multiplier 143 based at least in part on the bonusing key 146 determined at block 509.

At block 516, the cancellation service 126 can determine an award deduction. In some embodiments, the cancellation service 126 can determine the award deduction based at least in part on the award multiplier 143 determined at block 513. In some embodiments, the cancellation service 126 can communicate with the award service 123 to determine the award amount and determine the award deduction based at least in part on the award amount. In some embodiments, the cancellation service 126 can determine the award deduction based at least in part on action data 133 associated with the cancellation request 153 received at block 500. In some embodiments, the cancellation service 126 can determine an award deduction based at least in part on the unique action identifier 139 identified at block 506.

At block 519, the cancellation service 126 can return the refund amount. The cancellation service 126 can be configured to return the refund amount calculated at block 503 to a user. In some embodiments, the cancellation service 126 can initiate a return of the refund amount through another service. In some embodiments, the cancellation service 126 can return the refund amount to a balance associated with a user associated with the cancellation request 153 received at block 500.

At block 523, the cancellation service 126 can deduct the award deduction. The cancellation service 126 can be configured to deduct the award deduction determined at block 516 from a user. In some embodiments, the cancellation service 126 can deduct the award deduction from a balance associated with a user. In some embodiments, the cancellation service 126 can initiate a deduction of award deduction through another service, such as the award service 123. In some embodiments, the cancellation service 126 can deduct the award deduction from a balance associated with a user associated with the cancellation request 153 received at block 500.

At block 526, the cancellation service 126 can forward the cancellation request 153. In some embodiments, the cancellation service 126 can be configured to forward the cancellation request 153 to a user, to a processing service 109, to a POS system 106, or to another system or service. In some embodiments, the cancellation service 126 can forward a cancellation confirmation. After block 526, the flowchart of FIG. 5 comes to an end.

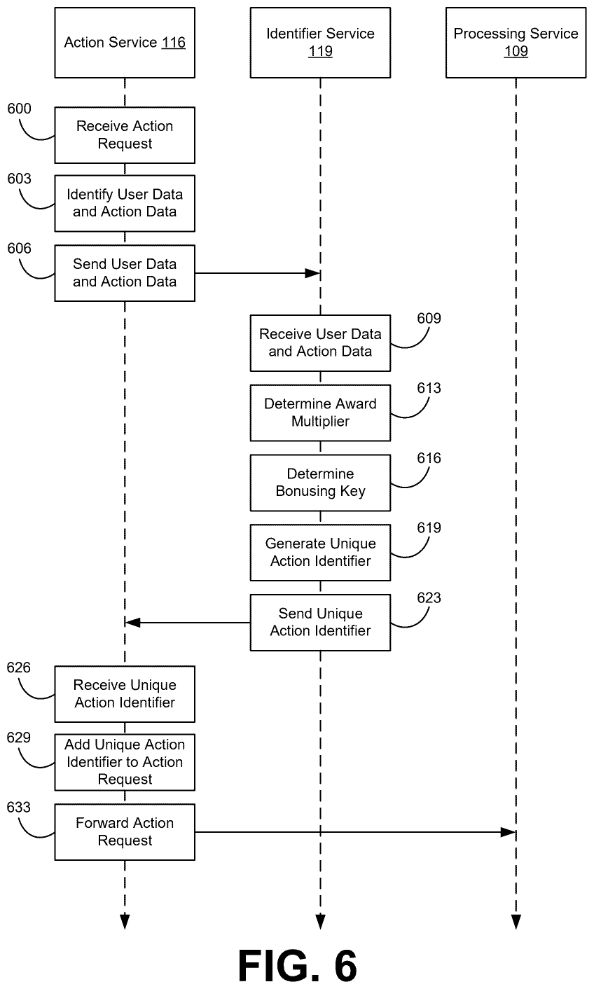

Moving on to FIG. 6, shown is a sequence diagram that provides one example of the interactions between the action service 116, the identifier service 119, and the processing service 109. The sequence diagram of FIG. 6 provides merely an example of the many different types of potential interactions between the action service 116, the identifier service 119, and the processing service 109. As an alternative, the sequence diagram of FIG. 6 can be viewed as depicting an example of elements of a method implemented within the network environment 100.

Beginning with block 600, the action service 116 can be configured to receive an action request 129. In some embodiments, the action request 129 can be received through the network 113 from a POS system 106. In some embodiments, the action service 116 can receive the action request 129 from another system or service in the network environment 100. In some embodiments, the action service 116 can obtain the action request 129 from the data store 156.

At block 603, the action service 116 can identify user data 136 and action data 133. In some embodiments, the action service 116 can extract action data 133 from the action request 129 and identify user data 136 based at least in part on the action data 133. In some embodiments, the action service 116 can extract action data 133 and user data 136 from the action request 129. The action service 116 can be configured to identify the user data 136 and the action data 133 simultaneously or in succession. In some embodiments, the action service 116 can identify action data 133 and user data 136 from the data store 156.

At block 606, the action service 116 can send the user data 136 and action data 133. In some embodiments, the action service 116 can send the user data 136 and action data 133 to the identifier service 119 to determine an award multiplier 143.

At block 609, the identifier service 119 can receive user data 136 and action data 133. In some embodiments, the identifier service 119 can receive the user data 136 and the action data 133 from the action service 116. In some embodiments, the identifier service 119 can receive the user data 136 and the action data 133 simultaneously or in succession. In some embodiments, the identifier service 119 can obtain the user data 136 and the action data 133 from the data store 156.

At block 613, the identifier service 119 can determine an award multiplier 143. The identifier service 119 can be configured to analyze the action data 133 and the user data 136 against a set of rules to determine the appropriate award multiplier 143 for the action request 129. In some embodiments, the identifier service 119 can be configured to receive the award multiplier 143 from the action service 116.

At block 616, the identifier service 119 can determine a bonusing key 146. In some embodiments, the identifier service 119 can be configured to determine a bonusing key 146 which corresponds to the award multiplier 143 determined at block 613. In some embodiments, the identifier service 119 can determine the bonusing key 146 based at least in part on action data 133. In some embodiments, the identifier service 119 can determine the bonusing key 146 based at least in part on user data 136. In some embodiments, the identifier service 119 can determine the bonusing key 146 based at least in part on the action data 133 and the user data 136.

At block 619, the identifier service 119 can generate a unique action identifier 139. The identifier service 119 can be configured to generate a unique action identifier 139 based at least in part on the award multiplier 143. In some embodiments, the identifier service 119 can generate the unique action identifier 139 based at least in part on the bonusing key 146. In some embodiments, the identifier service 119 can generate the unique action identifier 139 based at least in part on user data 136. The identifier service 119 can be configured to generate the unique action identifier 139 according to a specific format. In some embodiments, the identifier service 119 can be configured to generate the unique action identifier 139 such that the unique action identifier 139 resembles a payment card number.

At block 623, the identifier service 119 can send the unique action identifier 139. In some embodiments, the identifier service 119 can send the unique action identifier 139 to the action service 116. In some embodiments, the identifier service can send the unique action identifier 139 to a data store 156.

At block 626, the action service 116 can receive a unique action identifier 139. In some embodiments, the action service 116 receives the unique action identifier 139 in response to having sent the user data 136 and action data 133. In some embodiments, the action service 116 receives the unique action identifier 139 from the identifier service 119.

At block 629, the action service 116 can add the unique action identifier 139 to the action request 129. In some embodiments, the action service 116 can modify the action request 129 to include the unique action identifier 139. For example, the action service 116 can replace a payment card number included in the action request 129 with the unique action identifier 139.

At block 633, the action service 116 can forward the action request 129. In some embodiments, the action service 116 forwards the action request 129 to a processing service 109. In some embodiments, the action service 116 forwards a modified action request 129 to a processing service 109 of a third-party vendor. After block 633, the sequence diagram of FIG. 6 comes to an end.

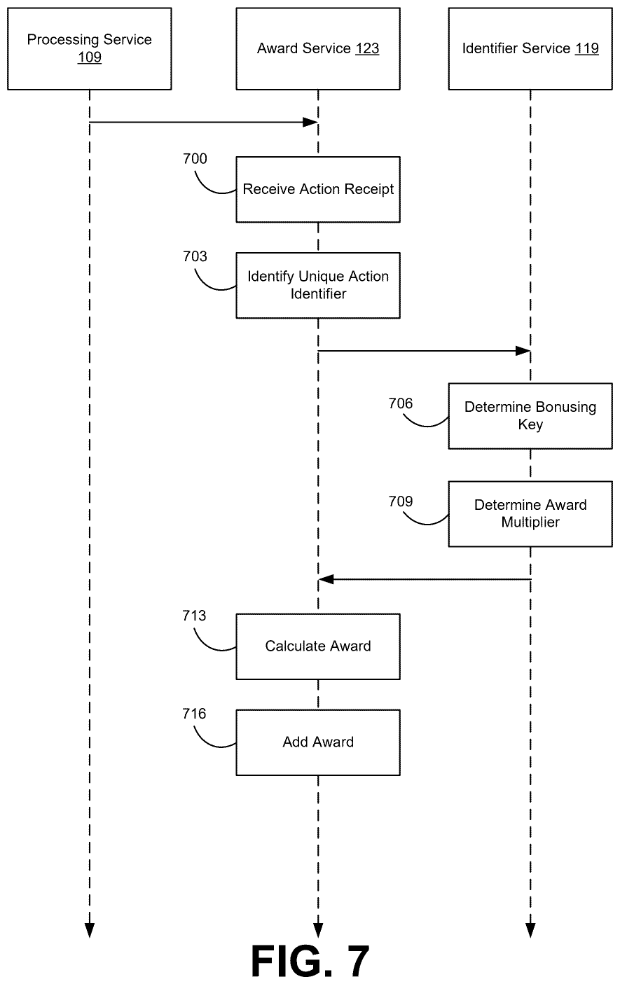

Turning now to FIG. 7, shown is a sequence diagram that provides one example of the interactions between the processing service 109, the award service 123, and the identifier service 119. The sequence diagram of FIG. 7 provides merely an example of the many different types of potential interactions between the processing service 109, the award service 123, and the identifier service 119. As an alternative, the sequence diagram of FIG. 7 can be viewed as depicting an example of elements of a method implemented within the network environment 100.

Beginning with block 700, the award service 123 can receive an action receipt 149. In some embodiments, the award service 123 can receive the action receipt 149 from a processing service 109.

At block 703, the award service 123 can identify a unique action identifier 139. In some embodiments, the award service 123 can be configured to search the action receipt 149 and identify the unique action identifier 139 from the contents of the action receipt 149. In some embodiments, the award service 123 can be configured to identify the unique action identifier 139 based at least in part on the action receipt 149 received at block 700. The award service 123 can send the unique action identifier 139 to the identifier service 119.

At block 706, the identifier service 119 can determine a bonusing key 146. In some embodiments, the identifier service 119 can be configured to determine a bonusing key 146 which corresponds to the unique action identifier 139 identified at block 703. In some embodiments, the identifier service 119 can determine the bonusing key 146 based at least in part on action data 133 associated with the action receipt 149. In some embodiments, the identifier service 119 can determine the bonusing key 146 based at least in part on user data 136. In some embodiments, the identifier service 119 can determine the bonusing key 146 based at least in part on action data 133 and user data 136.

At block 709, the identifier service 119 can determine an award multiplier 143. The identifier service 119 can be configured to determine the award multiplier 143 based at least in part on the unique action identifier 139. In some embodiments, the identifier service 119 can determine the award multiplier 143 based at least in part on the bonusing key 146. In some embodiments, the identifier service 119 can determine the award multiplier 143 based at least in part on user data 136. The identifier service 119 can send the award multiplier back to the award service 123.

At block 713, the award service 123 can calculate an award. The award service 123 can be configured to calculate an award for the action request 129 associated with the action receipt 149 received at block 700. In some embodiments, the award service 123 can be configured to calculate the award based at least in part on the award multiplier 143 determined by the identifier service 119 at block 709. In some embodiments, the award service 123 can be configured to calculate the award based at least in part on user data 136. In some embodiments, the award service 123 can be configured to calculate the award based at least in part on action data 133 associated with the action receipt 149.

At block 716, the award service 123 can add the award to a balance. The award service 123 can be configured to add the award calculated at block 713 to a balance associated with a user. In some embodiments, the award service 123 can add the award to a balance associated with the action receipt 149 received at block 700. In some embodiments, the award service 123 can be configured to add the award to some other balance. After block 716, the sequence diagram of FIG. 7 comes to an end.

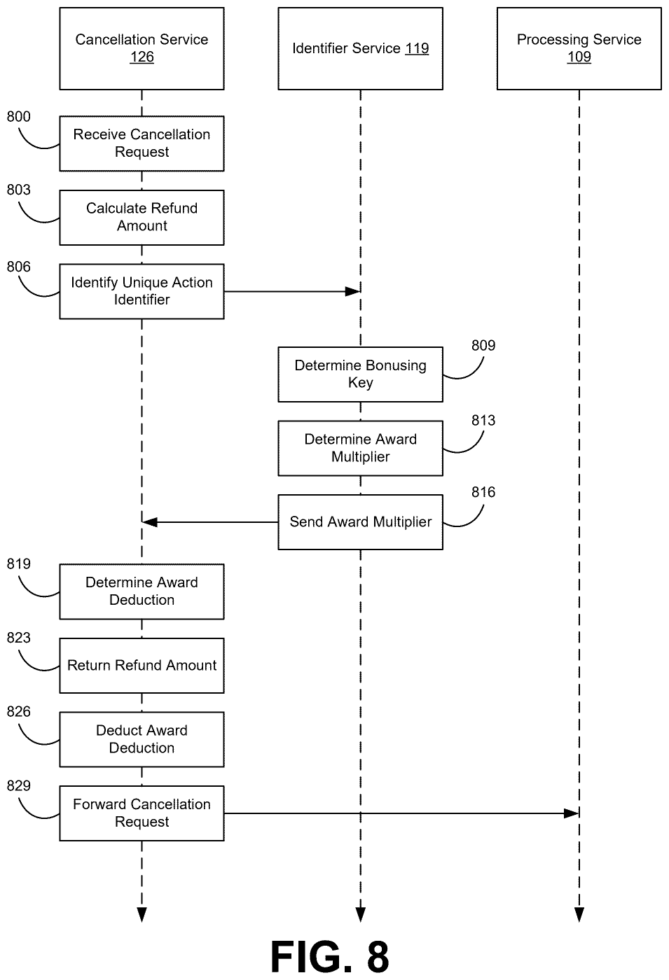

Referring next to FIG. 8, shown is a sequence diagram that provides one example of the interactions between the cancellation service 126, the identifier service 119, and the processing service 109. The sequence diagram of FIG. 8 provides merely an example of the many different types of potential interactions between the cancellation service 126, the identifier service 119, and the processing service 109. As an alternative, the sequence diagram of FIG. 8 can be viewed as depicting an example of elements of a method implemented within the network environment 100.

Beginning with block 800, the cancellation service 126 can receive a cancellation request 153. The cancellation service 126 can receive a cancellation request 153 from a user, a PoS system 106, a processing service 109 of a third-party vendor, or some other source. In some embodiments, the cancellation service 126 can receive a cancellation request 153 from another service (e.g., a fraud service, a client relations service, etc.) within the computing environment 103.

At block 803, the cancellation service 126 can calculate a refund amount. In some embodiments, the cancellation service 126 can extract action data 133 associated with the cancellation request 153 received at block 800 and calculate the refund amount based at least in part on the action data 133. In some embodiments, the cancellation service 126 can calculate a cancellation amount based at least in part on the action data 133. In some embodiments, the cancellation service 126 can calculate the refund amount based at least in part on the cancellation amount.

At block 806, the cancellation service 126 can identify a unique action identifier 139. The cancellation service 126 can be configured to identify a unique action identifier 139 associated with the cancellation request 153 received at block 800. In some embodiments, the cancellation service 126 can be configured to identify a unique action identifier 139 based at least in part on action data 133 associated with the cancellation request 153. The cancellation service 126 can send the unique action identifier 139 to the identifier service 119.

At block 809, the identifier service 119 can determine the bonusing key 146. In some embodiments, the identifier service 119 can determine the bonusing key 146 based at least in the unique action identifier 139 received from the cancellation service 126. In some embodiments, the identifier service 119 can return the bonusing key 146 to the cancellation service 126.

At block 813, the identifier service 119 can determine the award multiplier 143. The identifier service 119 can be configured to determine the award multiplier 143 based at least in part on the bonusing key 146 determined at block 809. In some embodiments, the cancellation service 126 can determine the award multiplier 143 based at least in part on the unique action identifier 139 received from the cancellation service 126. In some embodiments, the identifier service 119 can determine the award multiplier 143 based at least in part on the unique action identifier 139 and return the award multiplier 143 to the cancellation service 126.

At block 816, the identifier service 119 can send the award multiplier 143. In some embodiments, the identifier service 119 can send the award multiplier 143 to the cancellation service 126. In some embodiments, the identifier service 119 can send the award multiplier 143 to a data store 156 to be retrieved by the cancellation service 126.

At block 819, the cancellation service 126 can determine an award deduction. In some embodiments, the cancellation service 126 can determine the award deduction based at least in part on the award multiplier 143 received from the identifier service 119. In some embodiments, the cancellation service 126 can communicate with the award service 123 to determine the award amount and determine the award deduction based at least in part on the award amount. In some embodiments, the cancellation service 126 can determine the award deduction based at least in part on action data 133 associated with the cancellation request 153 received at block 800. In some embodiments, the cancellation service 126 can determine an award deduction based at least in part on the unique action identifier 139 identified at block 806.

At block 823, the cancellation service 126 can return the refund amount. The cancellation service 126 can be configured to return the refund amount calculated at block 803 to a user. In some embodiments, the cancellation service 126 can initiate a return of the refund amount through another service. In some embodiments, the cancellation service 126 can return the refund amount to a balance associated with a user associated with the cancellation request 153 received at block 800.

At block 826, the cancellation service 126 can deduct the award deduction. The cancellation service 126 can be configured to deduct the award deduction determined at block 819 from a user. In some embodiments, the cancellation service 126 can deduct the award deduction from a balance associated with a user. In some embodiments, the cancellation service 126 can initiate a deduction of award deduction through another service, such as the award service 123. In some embodiments, the cancellation service 126 can deduct the award deduction from a balance associated with a user associated with the cancellation request 153 received at block 800.

At block 829, the cancellation service 126 can forward the cancellation request 153. In some embodiments, the cancellation service 126 can be configured to forward the cancellation request 153 to the processing service 109 of a third-party vendor. In some embodiments, the cancellation service 126 can forward a cancellation confirmation. After block 829, the sequence diagram of FIG. 8 comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a record comprising action data and an action identifier associated with an action inquiry;
search contents of the record to obtain the action identifier from the contents of the record;
determine a plurality of keys corresponding to a plurality of multipliers;
select at least one key from the plurality of keys based at least in part on the action identifier;
determine a multiplier based at least in part on the at least one key;
calculate an amount based at least in part on the multiplier and the action data; and
add the amount to a balance associated with the action inquiry based at least in part on the action identifier.

2. The system of claim 1, wherein the machine-readable instructions further cause the computing device to at least:
receive a cancellation inquiry associated with the record, and the cancellation inquiry comprising at least a portion of the action data and the action identifier;
calculate a refund amount based at least in part on the action data;
determine a reduction based at least in part on the multiplier; and
initiate a cancellation of an action associated with the record.

3. The system of claim 2, wherein the machine-readable instructions that, when executed by the processor, initiate the cancellation of the action further cause the computing device to at least:
refund the refund amount based at least in part on the action inquiry; and
take the reduction from the balance associated with the action inquiry based at least in part on the action identifier.

4. The system of claim 2, wherein the machine-readable instructions, when executed by the processor, further cause the computing device to at least:
calculate a cancellation amount based at least in part on the cancellation inquiry; and
calculate the refund amount based at least in part on the cancellation amount.

5. The system of claim 1, wherein the action identifier comprises a first portion based at least in part on the multiplier and a second portion based at least in part on the action inquiry.

6. The system of claim 3, wherein the machine-readable instructions, when executed by the processor, further cause the computing device to at least forward the cancellation inquiry to a processing service.

7. The system of claim 3, wherein the machine-readable instructions, when executed by the processor, further cause the computing device to at least forward a verification to a processing service.

8. A method, comprising:
receiving, by a processor, a record, wherein the record comprises an action identifier and action data;
select at least one key based at least in part on the action identifier;
determining a multiplier based at least in part on the at least one key;
calculating an amount based at least in part on the action data and the multiplier; and
based at least in part on the calculated amount, adding the amount to a balance associated with the record.

9. The method of claim 8, further comprising:
receiving, by the processor, a cancellation inquiry comprising the action identifier;
extracting action data associated with the cancellation inquiry;
calculating a refund amount based at least in part on the action data;
obtaining the action identifier associated with the cancellation inquiry;
determining a reduction based at least in part on the multiplier; and
initiating a cancellation of an action associated with the record.

10. The method of claim 9, wherein initiating the cancellation of the action further comprises:
refunding the refund amount based at least in part on the cancellation inquiry; and
taking the reduction from the balance associated with the cancellation inquiry based at least in part on the action identifier.

11. The method of claim 9, further comprising:
calculating a cancellation amount based at least in part on the cancellation inquiry; and
calculating the refund amount based at least in part on the cancellation amount.

12. The method of claim 8, wherein the action identifier comprises a first portion based at least in part on the multiplier and a second portion based at least in part on an action inquiry associated with the record.

13. The method of claim 10, further comprising forwarding the cancellation inquiry to a processing service.

14. The method of claim 10, further comprising forwarding a verification to a processing service.

15. A non-transitory, computer-readable medium, comprising machine-readable instructions that, when executed by a processor of a computing device, cause the computing device to at least:
receive a record comprising action data and an action identifier associated with an action inquiry;
search contents of the record to obtain the action identifier from the contents of the record;
determine a plurality of keys corresponding to a plurality of multipliers;
select at least one key from the plurality of keys based at least in part on the action identifier;
determine a multiplier based at least in part on the at least one key;
calculate an amount based at least in part on the multiplier and the action data; and
add the amount to a balance associated with the action inquiry based at least in part on the action identifier.

16. The non-transitory, computer-readable medium of claim 15, wherein the machine-readable instructions, when executed by the processor of the computing device, further cause the computing device to at least:
receive a cancellation inquiry associated with the record, and the cancellation inquiry comprising at least a portion of the action data and the action identifier;
calculate a refund amount based at least in part on the action data;
determine a reduction based at least in part on the multiplier; and
initiate a cancellation of an action associated with the record.

17. The non-transitory, computer-readable medium of claim 16, wherein the machine-readable instructions that, when executed by the processor, initiate the cancellation of the action further cause the computing device to at least:
refund the refund amount based at least in part on the action inquiry; and
take the reduction from the balance associated with the action inquiry based at least in part on the action identifier.

18. The non-transitory, computer-readable medium of claim 16, wherein the machine-readable instructions, when executed by the processor, further cause the computing device to at least:
calculate a cancellation amount based at least in part on the cancellation inquiry; and
calculate the refund amount based at least in part on the cancellation amount.

19. The non-transitory, computer-readable medium of claim 15, wherein the action identifier comprises a first portion based at least in part on the multiplier and a second portion based at least in part on the action inquiry.

20. The non-transitory, computer-readable medium of claim 17, wherein the machine-readable instructions, when executed by the processor, further cause the computing device to at least forward the cancellation inquiry to a processing service.
